(19) United States
(12) Patent Application Publication
(10) Pub. No.: US 2019/0344348 A1
(43) Pub. Date: Nov. 14, 2019

(54) METHOD FOR MANUFACTURING THREE-DIMENSIONAL SHAPED OBJECT

(71) Applicant: PANASONIC INTELLECTUAL PROPERTY MANAGEMENT CO., LTD., Osaka (JP)

(72) Inventors: Akifumi NAKAMURA, Osaka (JP); Norio YOSHIDA, Nara (JP); Noriyasu NAKASHIMA, Osaka (JP)

(73) Assignee: PANASONIC INTELLECTUAL PROPERTY MANAGEMENT CO., LTD., Osaka (JP)

(21) Appl. No.: 16/461,470

(22) PCT Filed: Nov. 16, 2017
(86) PCT No.: PCT/JP2017/041254

§ 371 Date: May 16, 2019

(30) Foreign Application Priority Data
Nov. 17, 2016 (JP) 2016-224257

(51) Int. Cl. B22F 3/105; B33Y 10/00; B23K 26/082; B23K 26/06; B23K 26/342

(52) U.S. Cl. CPC B22F 3/1055; B33Y 10/00; B23K 26/342; B23K 26/0608; B23K 26/082

(57) ABSTRACT

The application relates to a method for manufacturing a three-dimensional shaped object by alternate repetition of a powder-layer forming and a solidified-layer forming, the repetition including: (i) forming a solidified layer by irradiating a predetermined portion of a powder layer with a light beam; and (ii) forming another solidified layer by forming a new powder layer on the formed solidified layer, and irradiating a predetermined portion of the newly formed powder layer with the light beam. A main beam and a sub beam are used as the light beam. The predetermined portion is irradiated with the sub beam prior to an irradiation of the predetermined portion with the main beam, the main beam having an irradiation energy density that melts the predetermined portion of the powder layer and the solidified layer located below the predetermined portion, the sub beam having an irradiation energy density that melts only the predetermined portion.

### TECHNICAL FIELD

The disclosure relates to a method for manufacturing a three-dimensional shaped object. More particularly, the disclosure relates to a method for manufacturing a three-dimensional shaped object in which a formation of a solidified layer is performed by an irradiation of a powder layer with a light beam.

### BACKGROUND OF THE INVENTION

Heretofore, a method for manufacturing a three-dimensional shaped object by irradiating a powder material with a light beam has been known (such method can be generally referred to as “selective laser sintering method”). The method can produce the three-dimensional shaped object by an alternate repetition of a powder-layer forming and a solidified-layer forming on the basis of the following (i) and (ii):

(i) forming a solidified layer by irradiating a predetermined portion of a powder layer with a light beam, thereby allowing a sintering of the predetermined portion of the powder or a melting and subsequent solidification of the predetermined portion; and

(ii) forming another solidified layer by newly forming a powder layer on the formed solidified layer, followed by similarly irradiating the powder layer with the light beam.

This kind of technology makes it possible to produce the three-dimensional shaped object with its complicated contour shape in a short period of time. The three-dimensional shaped object can be used as a metal mold in a case where an inorganic powder material (e.g., a metal powder material) is used as the powder material. While on the other hand, the three-dimensional shaped object can also be used as various kinds of models in a case where an organic powder material (e.g., a resin powder material) is used as the powder material.

Taking a case as an example wherein the metal powder is used as the powder material, and the three-dimensional shaped object produced therefrom is used as the metal mold, the selective laser sintering method will now be briefly described. As shown in FIGS. 9A-9C, a powder layer 22 with its predetermined thickness is firstly formed on a base plate 21 by a movement of a squeegee blade 23 (see FIG. 9A). Then, a predetermined portion of the powder layer is irradiated with a light beam L to form a solidified layer 24 (see FIG. 9B). Another powder layer is newly provided on the formed solidified layer, and is irradiated again with the light beam to form another solidified layer. In this way, the powder-layer forming and the solidified-layer forming are alternately repeated, and thereby allowing the solidified layers 24 to be stacked with each other (see FIG. 9C). The alternate repetition of the powder-layer forming and the solidified-layer forming leads to a production of a three-dimensional shaped object with a plurality of the solidified layers integrally stacked therein. The lowermost solidified layer 24 can be provided in a state of being adhered to the surface of the base plate 21. Therefore, there can be obtained an integration of the three-dimensional shaped object and the base plate. The integrated three-dimensional shaped object and base plate can be used as the metal mold.

### PATENT DOCUMENTS (RELATED ART PATENT DOCUMENTS)

Patent Document 1: Japanese Unexamined Patent Application Publication No. 2002-69507

### DISCLOSURE OF THE INVENTION

### Problems to be Solved by the Invention

The inventors of the present invention have found that the following problems may occur when a predetermined portion of a powder layer irradiated with a light beam to form a solidified layer. Specifically, as shown in FIGS. 7 to 8, upon an irradiation of a predetermined portion of a powder layer 22′ with a light beam L′, a phenomenon that a powder 19′ moves to an irradiated region 50′ where an irradiation with a light beam L′ is performed, the powder 19′ being located around the irradiated region 50′. A movement of the powder 19′ located around the irradiated region 50′ to the irradiated region 50′ may cause the powder 19′ at the irradiated region 50′ to be relatively increased, which may make a suitable provision of an irradiation heat energy of the light beam L′ to a base material impossible, the base material corresponding to an already formed solidified layer 24′. Thus, the base material as well as the powder 19′ in the irradiated region 50′ cannot be suitably melted, which may make a formation of a desired new solidified portion 24a the new solidified portion 24a′ being a composition element, of a new solidified layer 24′. Therefore, it may not be possible to finally obtain a high precise three-dimensional shaped object.

Under these circumstances, the present invention has been created. That is, an object of the present invention is to provide a method for manufacturing a three-dimensional shaped object which is capable of preventing a movement of a powder to an irradiated region which is irradiated with a light beam, the powder being a powder located around the irradiated region.

### Means for Solving the Problems

In order to achieve the above object, an embodiment of the present invention provides a method for manufacturing a three-dimensional shaped object by alternate repetition of a powder-layer forming and a solidified-layer forming, the repetition comprising:

(i) forming a solidified layer by irradiating a predetermined portion of a powder layer with a light beam, thereby allowing a sintering of the powder in the predetermined portion or a melting and subsequent solidification of the powder; and

(ii) forming another solidified layer by forming a new powder layer on the formed solidified layer, followed by an irradiation of a predetermined portion of the newly formed powder layer with the light beam,

wherein a main beam and a sub beam are used as the light beam, the main beam having an irradiation energy density which is capable of melting the predetermined portion of the powder layer and the solidified layer located below the predetermined portion, the sub beam having an irradiation energy density which is capable of melting only the predetermined portion, and

wherein the predetermined portion is irradiated with the sub beam prior to an irradiation of the predetermined portion with the main beam.

### Effect of the Invention

In the manufacturing method according to an embodiment of the present invention, it is possible to prevent a movement of a powder to an irradiated region which is irradiated with a light beam, the powder being a powder located around the irradiated region.

### BRIEF DESCRIPTION OF THE DRAWINGS

FIG. 1 is a perspective view schematically showing a manufacturing method according to an embodiment of the present invention.

FIG. 2A is a perspective view schematically showing an embodiment wherein sub beams opposed to each other are used.

FIG. 2B is a cross-sectional view schematically showing an embodiment wherein sub beams opposed to each other are used.

FIG. 2C is a cross-sectional view schematically showing an embodiment at a point in time after an irradiation with sub beams opposed to each other.

FIG. 2D is a cross-sectional view schematically showing an embodiment wherein an irradiation is performed with a main beam after an irradiation with sub beams opposed to each other.

FIG. 2E is a cross-sectional view schematically showing an embodiment wherein a new solidified portion is formed, the new solidified portion corresponding to a composition element of a new solidified layer.

FIG. 3A is a schematic view showing an embodiment wherein a contour of a solidified layer is formed according to an embodiment of the present invention.

FIG. 3B is a schematic view showing a conventional embodiment wherein a contour of a solidified layer is formed.

FIG. 4A is a perspective view schematically showing an embodiment wherein an intermittent irradiation of a predetermined portion of a powder layer is performed with a sub beam.

FIG. 4B is a perspective view schematically showing an embodiment wherein an intermittent irradiation of a predetermined portion of a powder layer is performed with a main beam as well as a sub beam.

FIG. 5A is a top plan view schematically showing an embodiment wherein a main beam and a sub beam are contacted with each other at a predetermined portion of a powder layer.

FIG. 5B is a top plan view schematically showing another embodiment wherein a main beam and a sub beam are contacted with each other at a predetermined portion of a powder layer.

FIG. 6A is a cross-sectional view schematically showing an irradiation embodiment with a main beam and a sub beam.

FIG. 6B is a cross-sectional view schematically showing another irradiation embodiment with a main beam and a sub beam.

FIG. 6C is a cross-sectional view schematically showing a still another irradiation embodiment with a main beam and a sub beam.

FIG. 7 is a perspective view schematically showing a technical problem found by the inventors of the present application.

FIG. 8 is a cross-sectional view schematically showing a technical problem found by the inventors of the present application.

FIG. 9A is a cross-sectional view schematically illustrating a laser-sintering/machining hybrid process in accordance with the selective laser sintering method upon a formation of a powder layer.

FIG. 9B is a cross-sectional view schematically illustrating a laser-sintering/machining hybrid process in accordance with the selective laser sintering method upon a formation of a solidified layer.

FIG. 9C is a cross-sectional view schematically illustrating a laser-sintering/machining hybrid process in accordance with the selective laser sintering method in a process of a stacking of solidified layers.

FIG. 10 is a perspective view schematically illustrating a construction of a laser-sintering/machining hybrid machine.

FIG. 11 is a flow chart of general operations of a laser-sintering/machining hybrid machine.

### MODES FOR CARRYING OUT THE INVENTION

The manufacturing method according to an embodiment of the present invention will be described in more detail with reference to the accompanying drawings. It should be noted that forms/forms and dimensional proportions in the drawings are merely for illustrative purposes, and thus not the same as those of the actual parts or elements.

The term “powder layer” as used in this description and claims means a “metal powder layer made of a metal powder” or “resin powder layer made of a resin powder”, for example. The term “predetermined portion of a powder layer” as used herein substantially means a portion of a three-dimensional shaped object to be manufactured. As such, a powder present in such predetermined portion is irradiated with a light beam, and thereby the powder undergoes a sintering or a melting and subsequent solidification to form a shape of a three-dimensional shaped object. Furthermore, the term “solidified layer” substantially means a “sintered layer” in a case where the powder layer is a metal powder layer, whereas term, “solidified layer” substantially means a “cured layer” in a case where the powder layer is a resin powder layer.

The term “upward/downward” direction directly or indirectly described herein corresponds to a direction based on a positional relationship between the base plate and the three-dimensional shaped object. A side for manufacturing the three-dimensional shaped object is defined as the “upward direction”, and a side opposed thereto is defined as the “downward direction” when using a position at which the base plate is provided as a standard.

### Selective Laser Sintering Method

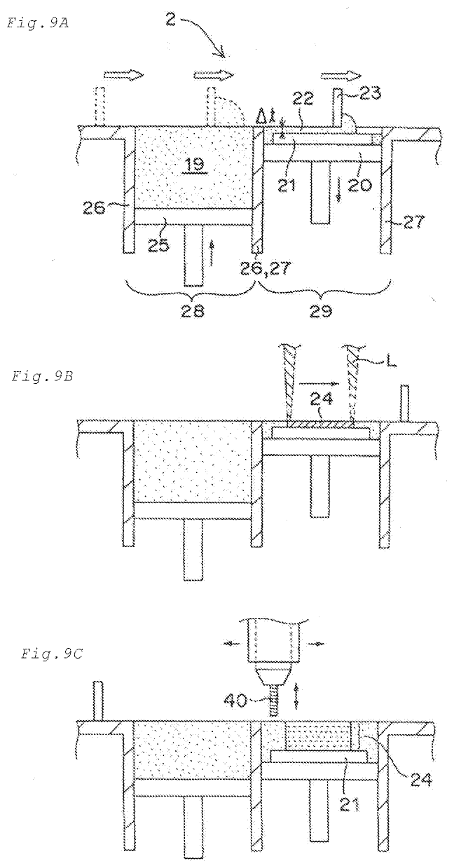

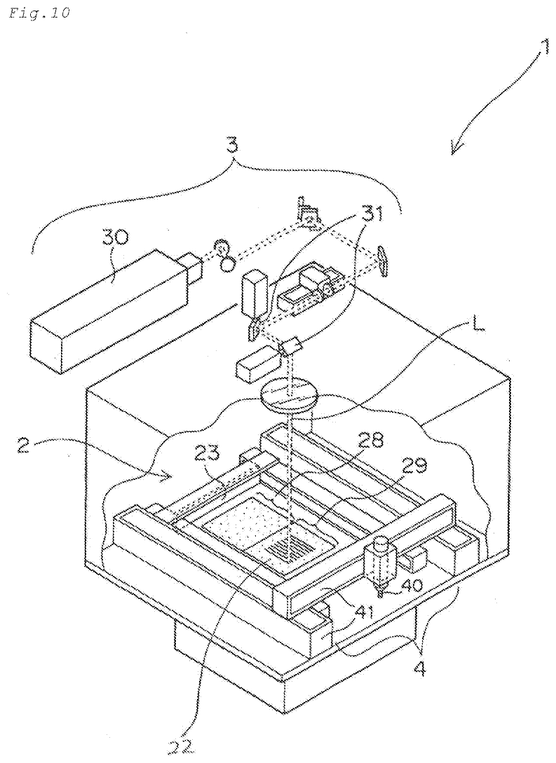

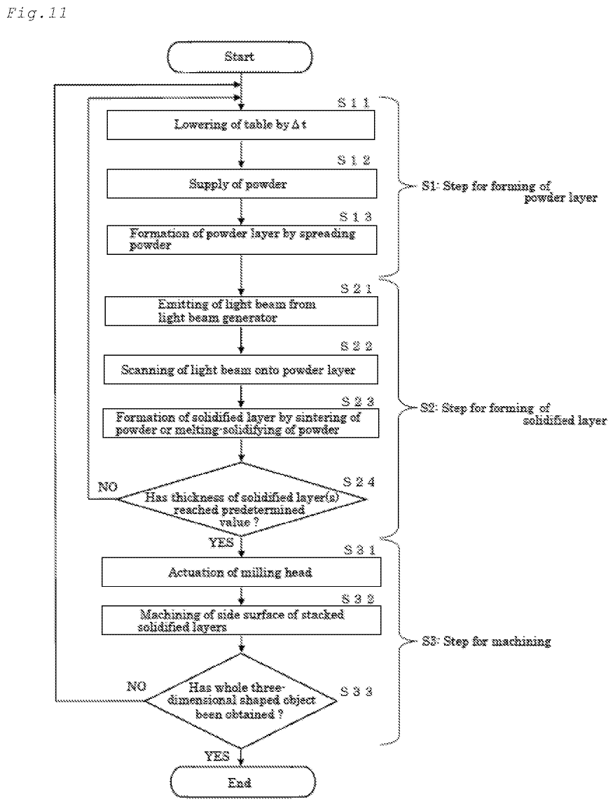

First of all, a selective laser sintering method, on which an embodiment of the manufacturing method of the present invention is based, will be described. By way of example, a laser-sintering/machining hybrid process wherein a machining is additionally carried out in the selective laser sintering method will be explained. Each of FIGS. 9A-9C schematically shows a process embodiment of the laser-sintering/machining hybrid. FIGS. 10 and 11 respectively show major constructions and operation flow regarding a metal laser sintering hybrid milling machine for enabling an execution of a machining process as well as the selective laser sintering method.

As shown in FIGS. 9A-9C and 10, the laser-sintering/milling hybrid machine 1 is provided with a powder layer former 2, a light-beam irradiator 3, and a machining means 4.

The powder layer former 2 is a means for forming a powder layer with its predetermined thickness through a supply of powder (e.g., a metal powder or a resin powder) as shown in FIGS. 9A-9C. The light-beam irradiator 3 is a means for irradiating a predetermined portion of the powder layer with a light beam “L”. The machining means 4 is a means for milling the side surface of the stacked solidified layers, i.e., the surface of the three-dimensional shaped object.

As shown in FIGS. 9A-9C, the powder layer former 2 is mainly composed of a powder table 25, a squeegee blade 23, a forming table 20 and a base plate 21. The powder table 25 is a table capable of vertically elevating/descending in a “storage tank for powder material” 28 whose outer periphery is surrounded with a wall 26. The squeegee blade 23 is a blade capable of horizontally moving to spread a powder 19 from the powder table 25 onto the forming table 20, and thereby forming a powder layer 22. The forming table 20 is a table capable of vertically elevating/descending in a forming tank 29 whose outer periphery is surrounded with a wall 27. The base plate 21 is a plate for a shaped object. The base plate is disposed on the forming table 20 and serves as a platform of the three-dimensional shaped object.

As shown in FIG. 10, the light-beam irradiator 3 is mainly composed of a light beam generator and a galvanometer mirror 31. The light beam generator 30 is a device for emitting a light beam “L”. The galvanometer mirror 31 is a means for scanning an emitted light beam “L” onto the powder layer, i.e., a scan means of the light beam “L”.

As shown in FIG. 10, the machining means 4 is mainly composed of a milling head 40 and an actuator 41. The milling head 40 is a cutting tool for milling the side surface of the stacked solidified layers, a i.e., the surface of the three-dimensional shaped object. The actuator 41 is a means for driving the milling head 40 to move toward the position to be milled.

Operations of the laser sintering hybrid milling machine 1 will now be described in detail. As can been seen from the flowchart of FIG. 11, the operations of the laser sintering hybrid milling machine are mainly composed of a powder layer forming step (S1), a solidified layer forming step (S2), and a machining step (S3). The powder layer forming step (S1) is a step for forming the powder layer 22. In the powder layer forming step (S1), first, the forming table 20 is descended by Δt (S11), and thereby creating a level difference At between an upper surface of the base plate 21 and an upper-edge plane of the forming tank 29. Subsequently, the powder table 25 is elevated by Δt, and then the squeegee blade 23 is driven to move from the storage tank 28 to the forming tank 29 in the horizontal direction, as shown in FIG. 9A. This enables a powder 19 placed on the powder table 25 to be spread onto the base plate 21 (S12), while forming the powder layer 22 (S13). Examples of the powder for the powder layer include a “metal powder having a mean particle diameter of about 5 μm to 100 μm” and a “resin powder having a mean particle diameter of about 30 μm to 100 μm (e.g., a powder of nylon, polypropylene, ABS or the like”. Following this step, the solidified layer forming step (S2) is performed. The solidified layer forming step (S2) is a step for forming a solidified layer 24 through the light beam irradiation. In the solidified layer forming step (S2), a light beam “L” is emitted from the light beam generator 30 (S21). The emitted light beam “L” is scanned onto a predetermined portion of the powder layer 22 by means of the galvanometer mirror 31 (S22). The scanned light beam can cause the powder in the predetermined portion of the powder layer to be sintered or be melted and subsequently solidified, resulting in a formation of the solidified layer 24 (S23), as shown in FIG. 9B. Examples of the light beam “L” include carbon dioxide gas laser, Nd:YAG laser, fiber laser, ultraviolet light, and the like.

The powder layer forming step (S1) and the solidified layer forming step (S2) are alternately repeated. This allows a plurality of the solidified layers 24 to be integrally stacked with each other, as shown in FIG. 9C.

When the thickness of the stacked solidified layers 24 reaches a predetermined value (S24), the machining step (S3) is initiated. The machining step (S3) is a step for milling the side surface of the stacked solidified layers 24, i.e., the surface of the three-dimensional shaped object. The milling head 40 (see FIG. 9C and FIG. 10) is actuated to initiate an execution of the machining step (S31). For example, in a case where the milling head 40 has an effective milling length of 3 mm, a machining can be performed with a milling depth of 3 mm. Therefore, supposing that “Δt” is 0.05 mm, the milling head 40 is actuated when the formation of the sixty solidified layers 24 is completed. Specifically, the side face of the stacked solidified layers 24 is subjected to the surface machining (S32) through a movement of the milling head 40 driven by the actuator 41. Subsequent to the surface machining step (S3), it is judged whether or not the whole three-dimensional shaped object has been obtained (S33). When the desired three-dimensional shaped object has not yet been obtained, the step returns to the powder layer forming step (S1). Thereafter, the steps S1 through S3 are repeatedly performed again wherein the further stacking of the solidified layers 24 and the further machining process therefor are similarly performed, which eventually leads to a provision of the desired three-dimensional shaped object.

### Manufacturing Method of the Present Invention

A manufacturing method according to an embodiment of the present invention is characterized by an embodiment wherein a predetermined portion of the powder layer is irradiated with the light beam in the selective laser sintering method as described above.

### Technical Idea of Present Invention

The present invention has such a technical idea that a predetermined portion of the powder layer is irradiated with at least two light beams. Specifically, the present invention has such a technical idea that the predetermined portion of the powder layer is irradiated with a main beam and at least one sub beam. More specifically, in an embodiment of the present invention, (i) a main beam and a sub beam are used as the light beam, the main beam having an irradiation energy density which is capable of melting a predetermined portion of a powder layer and a solidified layer located below the predetermined portion, the sub beam having an irradiation energy density which is capable of melting only the predetermined portion.
Furthermore, in addition to above feature, an embodiment of the present invention, (ii) a predetermined portion of a new powder layer is irradiated with the sub beam prior to an irradiation thereof with the main beam.

The phrase “main beam” as used herein means, in a broad sense, a beam having a main function that an irradiation of a predetermined portion of the powder layer causes a powder in the predetermined portion to be sintered or to be melted and subsequently solidified. The phrase “main beam” as used herein means, in a narrow sense, a beam having an irradiation energy density which allows a solidified layer located below a predetermined portion of a new powder layer to be melted. On the other hand, the phrase “sub beam” as used herein means a beam which plays a role of assisting the main beam in a broad sense and also means a beam having an irradiation energy density which enable only the predetermine portion of the new powder layer to be melted, but which does not enable the solidified layer located below the predetermined portion to be melted. The phrase “irradiation with the sub beam prior to irradiation with the main beam” as used herein substantially means “earlier irradiation of the predetermined portion of the powder layer th the sub beam temporally and subsequent irradiation with the main beam”.

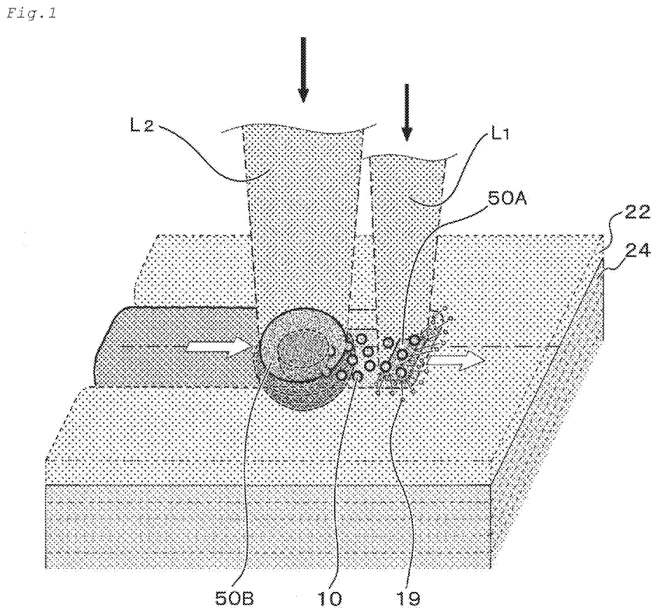

In the manufacturing method according to an embodiment of the present invention, a predetermined portion of the powder layer 22 is irradiated with a sub-beam L₁ prior to an irradiation of the predetermined portion with a main beam L₂ as described above (see FIG. 1). The irradiation of the predetermined portion of the powder layer 22 with the sub beam L¹ causes a sub beam-irradiated region 50A₁ to be in a melt state As described above, the sub beam L₁ melts only the predetermined portion of the powder layer 22 which is the sub beam-irradiated region 50A₁. That is described for a confirmation that the sub beam L₁ does not melt the solidified layer 24, which serves as a base material, located below the predetermined portion. The sub beam-irradiated region 50A₁ in the melt state causes the powder 19 around the sub beam-irradiated region 50A₁ to be attracted or moved to a side of the sub beam-irradiated region 50A₁. Thus, the sub-beam irradiated region 50A₁, the powder 19 in the irradiation region 50A₁ and the above-described attracted powder 19 are integrated to form an “integrated product 10 in a shape of a ball”, the integrated product 10 having a diameter size relatively larger than that of the powder 19″. A formation of the integrated product 10 in the shape of the ball enables a gap (i.e., a clearance) to be substantially formed, the gap being provided between “the integrated product 10” and “the powder 19 not attracted to the side of the sub beam-irradiated region 50A₁”. Upon an irradiation with the main beam L₂ at a later time in a state that the gap is formed, an existence of the gap enables a movement of the powder 19 to a main beam-irradiated region 50B₁ which is irradiated with the main beam L₂ to be prevented. Specifically, the existence of the gap enables a prevention of the movement of “the powder 19 not attracted to the side of the sub beam-irradiated region 50A₁” to the main beam-irradiated region 50B; which is irradiated with the main beam L₂. Namely, in an embodiment of the present invention, the sub beam L₁ can function as a beam which prevents a movement of the powder 19 to the main beam-irradiated region 50B₁ which is irradiated with the main beam L₂.

Thus, in the present invention, (1) an increase of the powder 19 at the main beam-irradiated region 50B₁ which is irradiated with the main beam L₂ can be prevented. In addition, in a state that integrated products in the shape of the ball 10 are formed, a minute gap may be formed between the integrated products 10 each of which is in the shape of the ball compared with a state that the integrated product in the shape of the ball 10 is not formed (i.e., a state that the powder layer is formed). Thus, (2) a local exposure of a solidified layer located in a lower region is possible, the solidified layer serving as a base material. As a result, the solidified layer serving as the base material can be suitably provided with an irradiation heat energy of the main beam L₂, which enables the base material as well as the powder 19 in the main beam-irradiated region 50B₁ to be in a suitable melt state. Therefore, a desired new solidified portion as a composition element of a new solidified layer can be formed, and thus a high accurate three-dimensional shaped object can be finally obtained.

A prevention of the movement of the powder 19 to the main beam-irradiated region 50B₁ can provide the following effects. Specifically, in case when a melt portion is formed by a melt of the powder 19 in the main beam-irradiated region 50B₁ with the main beam L₂, it is possible to prevent a melt material of the powder 19 from scattering around the main beam-irradiated region 50B₁, the scattering of the melt material being due to no incorporation of the melt material into the melt portion, the melt material being formed by the powder 19 in a process of a movement to the main beam-irradiated region 50 due to the melt portion having a relatively high temperature in the main beam-irradiated region 50B₁. In a case of the scatter of the melt material of the powder 19 around the main beam-irradiated region 50B₁ (e.g., on the already formed solidified layer), it is impossible to suitably form a new powder layer at a later time. In this regard, the prevention of the melt material of the powder 19 is possible according to an embodiment of the present invention. As a result, a desired new solidified portion as the composition element of the new solidified layer can be formed, and thus a high accurate three-dimensional shaped object can be finally obtained.

The prevention of the movement of the powder 19 to the main beam-irradiated region 50B₁ can also provide the following effects. Specifically, upon the irradiation of the predetermined portion of the powder layer with the beam, a shrinkage stress may occur due to the melt and the subsequent solidification of the powder of the predetermined portion. The occurrence of the shrinkage stress may lead to the warpage-deformation of the three-dimensional shaped object to be finally obtained. In this regard, the movement of the powder 19 to the main beam-irradiated region 50B₁ can be prevented in an embodiment of the present invention, which makes it possible to prevent an increase of the powder 19 in the main. beam-irradiated region 50B₁. The prevention of the increase of the powder 19 in the main beam-irradiated region 50B₁ may result in a prevention of a formation of an excessive melt portion. The prevention of the formation of the excessive melt portion enables an occurrence of an excessive shrinkage stress to be reduced, the shrinkage stress being due to the solidification of the melt portion by a cooling at a later time. The reduction of the occurrence of the excessive shrinkage stress enables the warpage-deformation of the three-dimensional shaped object to be finally obtained to be prevented. Thus, the high accurate three-dimensional shaped object can be finally obtained.

Furthermore, the manufacturing method according to an embodiment of the present invention may adopt the following embodiments.

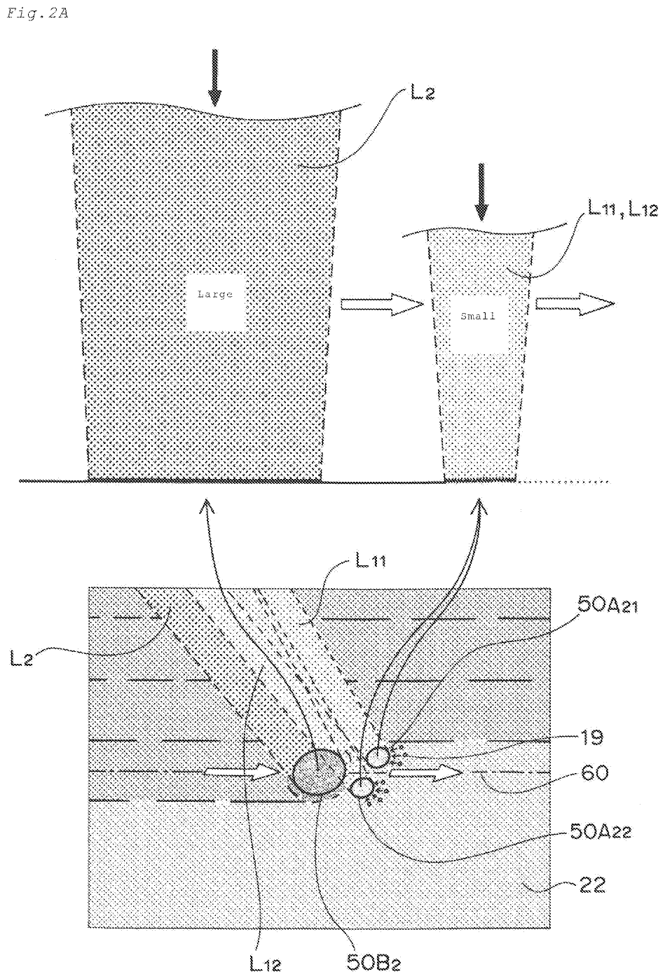

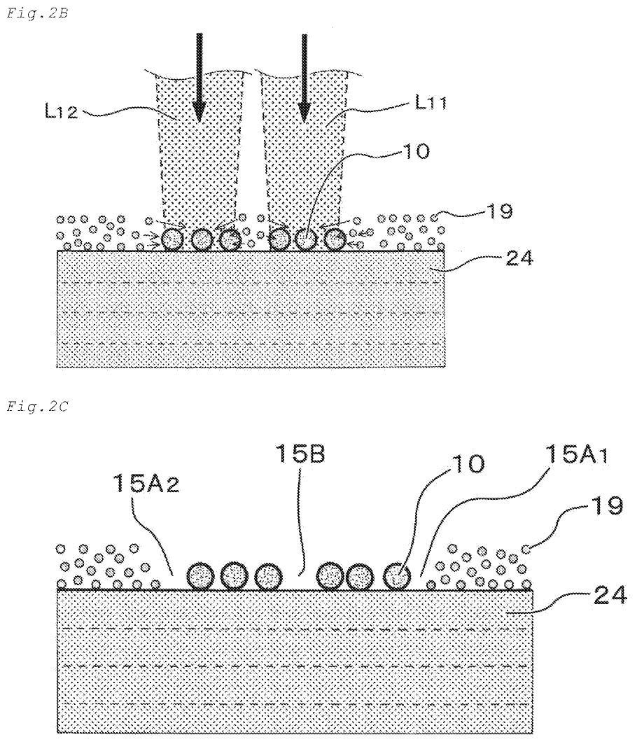

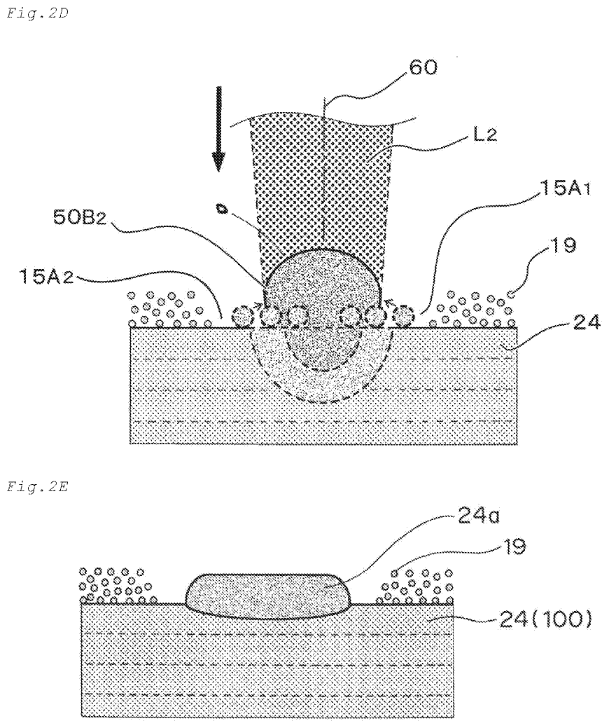

According to an embodiment, the main beam may have an irradiation energy density relatively larger than that of the sub beam, and the sub beam may have an irradiation energy density relatively smaller than that of the main beam (see FIG. 2A).

Specifically, while a ratio α (%) of the irradiation energy density (J/mm²) of the sub beam to the irradiation energy density (J/mm²) of the main beam is not particularly limited, the ratio may be 1<α<100, 10<α<60 preferably, and 20<α<50 more preferably. Furthermore, due to the ratio, a ratio β (%) of an area of the sub beam-irradiated region to an area of the main beam-irradiated region may be 1<β<100, 20<β<80 preferably, and 30<β<50 more preferably, the area of the sub beam-irradiated region being a region where the predetermined portion of the powder layer is irradiated with the sub beam, the area of the main beam-irradiated region being a region where the predetermined portion of the powder layer is irradiated with the main beam.

In a case that the irradiation energy density of the main beam L₂ is relatively larger, an irradiation heat energy of the main beam L₂ can be more suitably provided to the solidified layer as a base material. Thus, the powder 19 in the main beam-irradiated region 50B₂ and the base material can be made to be a more suitable melt state. On the other hand, in a case that the irradiation energy density of the sub beam L₁ is relatively smaller, only a predetermined portion of the powder layer 22 can be melted whereas the solidified layer as the base material can be suitably kept not to be the melt state, which makes it possible to more suitably form “an integrated product in a shape of a ball 10” having a diameter relatively larger than that of the powder 19, the integrated product being formed by an integration of “the powder 19 located in the sub beam-irradiated region 50A₂” with “the powder 19 around the sub beam-irradiated region 50A₂ attracted to the sub beam-irradiated region 50A₂”. Thus, a gap can be more suitably formed between the “integrated product 10” and “the powder 19 not attracted to the sub beam-irradiated region 50A₂”.

In this embodiment, a solidification density of a portion (i.e., a solidified portion) obtained by irradiating the predetermined portion of the powder layer with the main beam is relatively higher due to the main beam having the relatively larger irradiation energy density. On the other hand, a solidification density of the solidified portion obtained by irradiating the predetermined position of the powder layer with the sub-beam is relatively lower due to the sub-beam having the relatively smaller irradiation energy density. Since the solidified portion obtained by the irradiation of the predetermined portion of the powder layer with the sub beam has the relatively lower solidification density, the solidified portion obtained by the irradiation with the sub beam can be suitably melted, even if the predetermined position of the powder layer is irradiated with the main beam at a later time.

This embodiment is based on a condition that the main beam has the irradiation energy density relatively larger than that of the sub beam, and the sub beam has the irradiation energy density relatively smaller than that of the main beam. However, an irradiation embodiment of the light beam is not limited to the condition. The main beam and the sub beam each of which has the same irradiation energy density may be used if (1) a prevention of increase of the powder 19 in the main beam-irradiated region 50B₁ is possible and also (2) a local exposure of the solidified layer at a lower region serving as the base material is possible, in order to suitably provide the solidified aver serving as the base material with the irradiation heat energy of the main beam L₂.

In this case, an use of a single light beam substantially enables “a melt of only the predetermined portion of the powder layer” to be performed, which corresponds to a function of the sub-beam, and also enables “a melt of the predetermined portion of the powder layer and that of the solidified layer located below the predetermined portion” to be performed, which corresponds to a function of the main beam. That is, the single light beam can have both of the function of the main beam and the function of the sub beam. Thus, it is possible to improve an irradiation efficiency by the light beam. Furthermore, in a case that the single light beam has the above both functions, it is preferable that an use thereof having an excessive large or excessive small absolute value of the irradiation energy density is avoided in advance in order to suitably perform “the melt of only the predetermined portion of the powder layer” and “the melt of the predetermined portion of the powder layer and that of the solidified layer located below the predetermined portion”.

According to an embodiment, a plurality of locations may be irradiated with the sub beam, the plurality of the locations being opposed to each other across a scanning center line of the main beam. The phrase “scanning center line” as used herein substantially means a central region of a scanning line of the main beam.

In this embodiment, for example, a predetermined portion of the powder layer 22 is irradiated with two sub beams L₁ (first sub beam L₁₁ and second sub beam L₁₂), which are opposed to each other across the scanning center line 60 prior to an irradiation with the main beam L₂ (see FIG. 2A). When the first sub beam L₁₁ and the second sub beam L₁₂ are opposed to each other across the scanning center line 60, a first sub beam-irradiated region 50A₂₁ and a second sub beam-irradiated region 50A₂₂ are also opposed to each other across the scanning center line 60. (See FIG. 2A). That is, the first sub beam-irradiated region 50A₂₁ and the second sub beam irradiated region 50A₂₂ may be provided to be spaced apart from each other across the scanning center line 60. The number of the sub beams is not limited to two, and it may be three or more on a condition that the sub beams are opposed to each other. While not being particularly in an embodiment shown in FIGS. 2A and 2B, predetermined portions of the powder layer 22 are irradiated with the first sub beam L₁₁ and the second sub beam L₁₂ which are spaced apart from each other.

An irradiation with the first sub beam L₁₁ and the second sub beam L₁₂ causes the powder 19 each located around the first sub beam-irradiated region 50A₂₁ and the second sub beam-irradiated region 50A₂₂ to be attracted to each of the sub beam-irradiated regions, due to the each sub beam-irradiated region in a melt state. Thus, the powder 19 originally located in each sub beam-irradiated region and a peripheral powder 19 attracted to each sub beam-irradiated region are integrated to each form “an integrated product in a shape of a ball 10” having a relatively larger diameter than that of the powder 19 (see FIG. 2B). Due to a formation of each “integrated product in the shape of ball 10”, gaps 15A₁ and 15A₂ (i.e., clearance) are respectively formed between the “integrated product 10” and the “powder 19 not attracted to the sub beam-irradiated region 50_{A1}” (See FIG. 2C).

Furthermore, as described above, the first sub beam-irradiated region 50A₂₁ and the second sub beam irradiated region 50A₂₂ are provided to be spaced apart from each other across the scanning center line 60 according to this embodiment. Thus, it is possible to form a gap 15B between “the integrated product in the shaped of ball” 10 at the first sub beam-irradiated region and that at the second sub beam-irradiated region (See FIG. 2C). That is, each of the first sub beam. L₁₁ and the second sub beam L₁₂ can function as a beam which prevents a movement of the powder 19 to a periphery of the scanning center line 60 of the main beam L₂.

In a case that an irradiation with the main beam L₂ is performed at a later time in a formation state of the two gaps 15A₁ and 15A₂, it is possible to more suitably prevent a movement of the powder 19 to the main beam-irradiated region 50B₂ where the irradiation with the main beam L₂ is performed due to a presence of the gaps (see FIG. 2D). Specifically, the gaps makes it possible to more suitably prevent a movement of “powder 19 not attracted to the each sub beam-irradiated region 50A₂” to the main beam-irradiated region 50B₂ where an irradiation with the main beam L₂ is performed. Thus, an increase of the powder 19 in the main beam-irradiated region 50B₂ irradiated with the main beam L₂ can be more suitably prevented.

Furthermore, in a case that an irradiation with the main beam L₂ is performed at a later time in a formation state of the gap 15B in a comparison with a non-formation state of the integrated product in the shape of ball 10 (i.e., a powder layer-formation state), the gap 15B makes it possible to expose the solidified layer at a lower region serving as the base material along the scanning center line 60 of the main beam 60 between “the integrated product in the shape of ball 10” formed. on the side of the sub beam-irradiated region and “the integrated product in the shape of ball 10” formed on the side of the second sub beam-irradiated region. Thus, the irradiation heat energy of the main beam L₂ can be more suitably provided to the solidified layer serving as the base material. Thus, the powder 19 in the main beam-irradiated region 50B₁ and the base material can be more suitably melt. As a result, it is possible to form a desired new solidified portion as a composition element of a new solidified layer, and thus a high precise three-dimensional shaped object can be finally obtained more suitably (see 2E).

According to an embodiment, a location distal a scanning center line of the main beam may be irradiated with the sub beam based on a virtual contour to be a contour of the solidified layer. The “virtual contour to be the contour of the solidified layer” as used herein substantially indicates a portion corresponding to a contour of the solidified layer to be formed at a later time, in the predetermined portion of the powder layer where an irradiation with the main beam is performed.

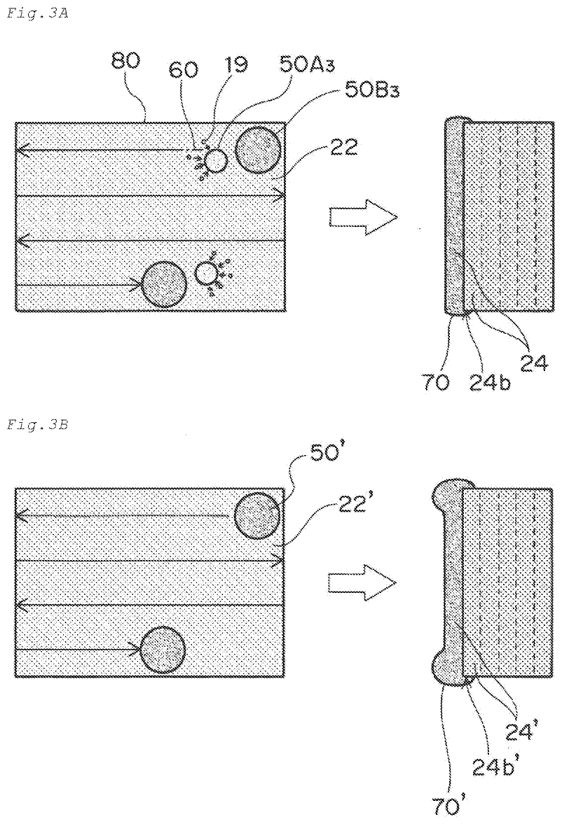

When irradiating a predetermined portion of the powder layer with the beam to form a solidified layer 24′ in accordance with the selective laser sintering method, a relatively large raised solidified portion 70′ may occur at a contour 24b′ of the solidified layer 24′ (See FIG. 3B). While not being bounded by a particular theory, when the beam directly contacts a boundary region between a portion where the base material corresponding to an already formed solidified layer 24′ and a portion having no base material, it is conceived that a powder on the base material and a powder at a portion having no base material are both melted together, and then a melt portion may raise due to a surface tension, thereby which may cause an occurrence of the raised solidified portion 70′ at the contour 24b′ of the solidified layer 24′. Also, as found by the inventors of the present application, the powder around the irradiated region where an irradiation with the light beam is performed may move to the irradiated region. Thus, an amount of a powder on the base material in a periphery of the boundary region may be relatively increased. Thus, a relatively larger raised solidified portion 70′ may occur at the contour 24b′ of the solidified layer 24′, which may make it difficult to finally obtain a high accurate three-dimensional shaped object.

In light of the above matters, a location distal to a scanning center line 60 of the main beam is irradiated with a single sub beam based on a virtual contour 80 to be a contour 24b of the solidified layer 24 according to this embodiment, as shown in FIG. 3A, for example. The number of the sub beam is not limited to one, and it may be two or more in a condition that the sub beam is provided at the location distal to the scanning center line 60 of the main beam. As shown in FIG. 3A, in a case that the sub beam is provided at the location distal to the scanning center line 60 of the main beam based on the virtual contour 80, only the powder in a sub beam irradiated area 50A₃ formed on a side distal to the scanning center line 60 may be in a melt state in advance.

Due to the melt state in advance of only the powder in the sub beam-irradiated area 50A₃ formed on the side distal to the scanning center line 60, the powder 19 around the sub beam-irradiated region 50A₃ may be moved intentionally to the sub beam-irradiated region 50A₃. In particular, the powder 19 located proximal to the scanning center line 60 may be suitably moved to the sub beam-irradiated region 50A₃ at this time, which can prevent a movement of the powder 19 to a proximal side of the scanning center line 60. Thus, it is possible to prevent a movement of the powder 19 to a region between the scanning center line 60 of the main beam and the virtual contour 80 due to an irradiation of the predetermined portion with the sub beam. In light of the above matters, the sub beam can function as a beam which prevents the movement of the powder 19 to the region between the scanning center line 60 and the virtual contour 80 in this embodiment.

The prevention of the movement of the powder 19 to the region between the scanning center line 60 and the virtual contour 80 makes it possible to prevent an increase of the powder 19 at the main beam-irradiated region 50B₃ on the base material a periphery of the boundary region between the portion where the base material is formed and the portion having no base material, ever if the main beam directly contacts the boundary region. Thus, it is possible to relatively decrease a size of a raised solidified portion 70 which may occur at a contour 24b of the solidified layer 24, the raised solidified portion 70 being due co a raise of a melt portion by a surface tension, the melt portion being formed by a melt of both of a powder on the base material and a powder at a portion having no base material. Thus, a relatively smaller raised solidified portion 70 makes it easy to finally obtain a high accurate three-dimensional shaped object.

According to an embodiment, an intermittent irradiation of the predetermined portion of the powder layer with the sub beam is performed. The phrase “intermittent irradiation” as used herein means an irradiation of the predetermined portion of the powder layer with the sub beam at a constant time interval in a broad sense.

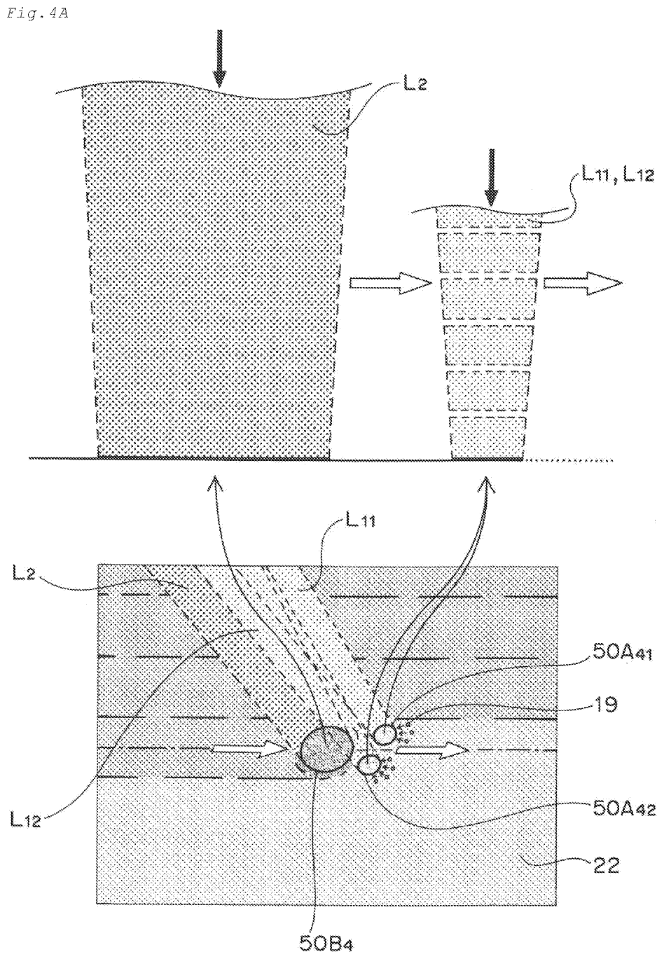

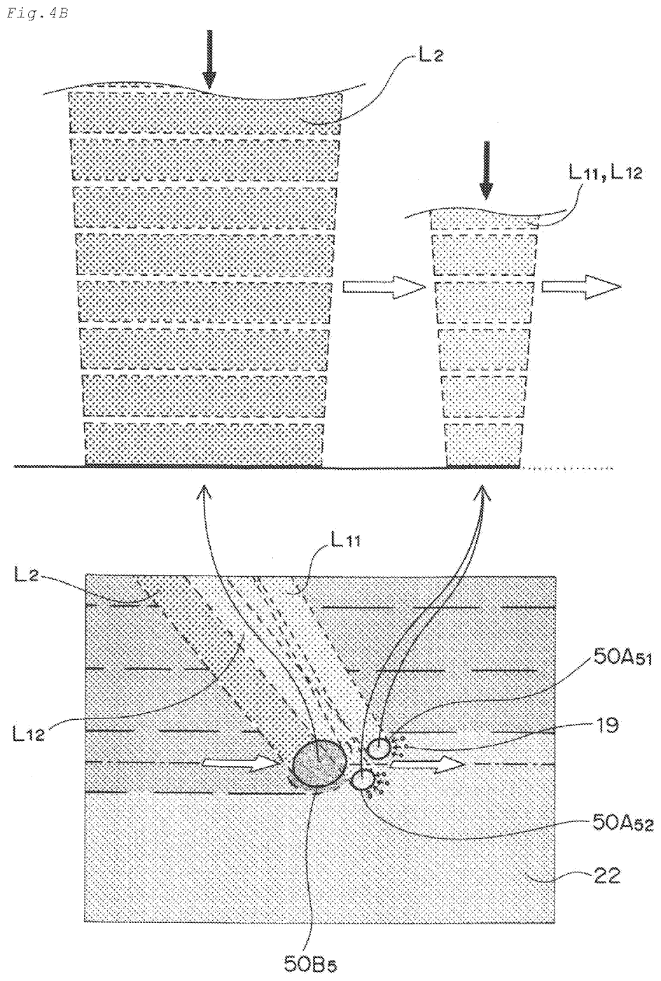

In this embodiment, for example, prior to the irradiation with the main beam L₂, the predetermined portion of the powder layer 22 is irradiated with two sub beams L₁ (i.e., a first sub beam L₁₁ and a second sub beam L₁₂) which are opposed to each other across the scanning center line 60 (see FIG. 4A). The number of the sub beams is not limited to two, and it may be single or three or more.

In an embodiment shown in FIG. 4A, the predetermined portion of the powder layer 22 is intermittently irradiated with the first sub beam L₁₁ and the second sub beam L₁₂ which are spaced apart from each other. The intermittent irradiation with the first sub beam L₁₁ and the second sub beam L₁₂ enables a powder each located in a first sub beam-irradiated region 50A₄₁ and a second sub beam irradiated region 50A₄₂ to be in a melt state in advance “as necessary”, the first sub beam-irradiated region 50A₄₁ being a region where an irradiation is performed with the first sub beam the second sub beam-irradiated region 50A₄₂ being a region where an irradiation is performed with the second sub beam L₁₂.

For example, while not being particularly limited, in a case when it is determined that a movement of the powder to the main beam-irradiated region where an irradiation is performed with the main beam cannot be sufficiently prevented, the intermittent irradiation with the sub beam may be performed. When the predetermined portion of the powder layer is irradiated with the first sub beam L₁₁ and the second sub beam L₁₂, the powder of the predetermined portion of the powder layer can be melted in advance as necessary. Namely, this embodiment is characterized in that the intermittent irradiation is performed only when it is determined that the irradiation the predetermined portion of the powder layer 22 with the first sub beam L₁₁ and the second sub beam L₁₂ is necessary.

As shown in FIG. 4A, the melt state in advance as necessary of the powder in the predetermined portion of the powder layer enables the powder 19 around the first sub beam irradiated region 50A₄₁ to be moved to the first sub beam irradiated region 50A₄₁ as necessary, and also enables the powder 19 around the second sub beam irradiated region 50A₄₂ to be moved to the second sub beam irradiated region 50A₄₂ as necessary. Thus, it is possible to prevent a movement of the powder 19 to a region between the first sub beam irradiated region 50A₄₁ and the second sub beam irradiated region 50A₄₂ as necessary, which may be spaced apart from each other. That is, the movement of the powder 19 to a periphery of the scanning center line 60 of the main beam L₂ can be prevented as necessary.

In light of the above matters, according to this embodiment, the intermittent irradiation is performed only when it is determined that the irradiation of the predetermined portion of the powder layer 22 with the first sub beam L₁₁ and the second sub beam L₁₂ is necessary. As a result, the irradiation with the sub beam as necessary makes it possible to improve a controllability of the melt state of the powder in the predetermined portion, compared with a continuous irradiation of the predetermined portion of the powder layer 22 with the sub beam for a melt of the powder in the predetermined portion.

Without being limited to the above embodiment, according to an embodiment, the predetermined portion of the powder layer may be irradiated with a sub beam which is capable of performing a control for changing an irradiation energy density. The phrase “control for changing the irradiation energy density” as used herein substantially means a temporally change of the irradiation energy density of the sub beam for the irradiation to the predetermined portion of the powder layer.

This embodiment is different from the above embodiment in that the irradiation of the sub beam is performed substantially continuously, whereas the irradiation energy density of the sub beam for the irradiation to the predetermined portion of the powder layer is temporally changed.

For example, while not being particularly limited, when it is determined that the movement of the powder to the main beam-irradiated region where the irradiation with the main beam is performed cannot be sufficiently prevented although the predetermined portion of the powder layer is irradiated with the sub beam having a predetermined irradiation energy density, upon the irradiation with the sub beam, the sub beam may be controlled to be changed to an irradiation energy density relatively larger than that of the sub beam already used. An irradiation with the sub beam having a relatively large irradiation energy density enables the powder in the sub beam irradiated region to be in a more melt state.

The powder in the sub beam irradiated region in the more melt state makes an movement of the powder around the sub beam-irradiated region thereto easier. As a result, in a case that the predetermined portion of the powder layer is irradiated with the two sub beams which are opposed to each other across the scanning center line prior to the irradiation with the main beam, it is possible to more effectively prevent a movement of the powder to a region between the first sub beam-irradiated region and the second sub beam-irradiated region which are opposed to each other. That is, the movement of the powder to a periphery of the scanning center line of the main beam can be more effectively prevented.

In light of the above matters, an irradiation energy density of the sub beam for the irradiation to the predetermined portion of the powder layer is temporally changed although a substantially continuous irradiation with sub beam is performed according to this embodiment. Thus, a melt state of the powder at the predetermined portion can be changed on the way, compared with a case that the sub-beam having the same irradiation energy density are irradiated substantially continuously. That is, due to a temporal change of the irradiation energy density of the sub beam for the irradiation to the predetermined portion the powder layer, a control lability of the melt state of the powder in the predetermined portion can be improved.

According to an embodiment, an intermittent irradiation of the predetermined portion of the powder layer with the main beam as well as the sub beam may be performed, compared with an embodiment shown in FIG. 4A. A description is omitted as to an overlapping portion in contents in the embodiment shown in FIG. 4A.

In this embodiment similarly to the embodiment shown in FIG. 4A, the predetermined portion of the powder layer 22 is intermittently irradiated with the first sub beam L₁₁ and the second sub beam L₁₂ which are spaced apart from each other. That is, this embodiment is characterized in that the intermittent irradiation is performed only when it is determined that the irradiation of the predetermined portion of the powder layer 22 with the first sub beam L₁₁ and the second sub beam L₁₂ is necessary. The intermittent irradiation makes it possible to prevent a movement of the powder 19 to a region between a first sub beam-irradiated region 50A₅₁ and a second sub beam-irradiated region 50A₅₂ as necessary, the first sub beam-irradiated region 50A₅₁ being a region where an irradiation with the first sub beam L₅₂ is performed, the second sub beam-irradiated region 50A₅₂ being a region where an irradiation with the second sub beam L₁₂ is performed. Thus, the movement of the powder 19 to a periphery of the scanning center line 60 of the main beam L₂ can be prevented as necessary.

Furthermore, in this embodiment, the intermittent irradiation of the predetermined portion of the powder layer 22 with the main beam L₂ as well as the sub beam may be performed. The intermittent irradiation of the predetermined portion of the powder layer with the main beam as well as the sub beam is different from an embodiment shown in FIG. 4A.

In a state that the movement of the powder 19 to the periphery of the scanning center line 60 of the main beam L₂ is prevented, the intermittent irradiation of the predetermined portion of the powder layer 22 with the main beam L₂ along the scanning center line 60 of the main beam L₂ makes it possible to prevent the movement of the powder 19 to a main beam-irradiated region 50B₂ as necessary, the main beam-irradiated region 50B₂ being a region where an irradiation with the main beam L₂ is performed. Thus, an increase of the powder 19 in the main beam-irradiated region 50B₂ can be prevented as necessary.

As described above, the intermittent irradiation of the predetermined portion of the powder layer 22 with the main beam L₂ as well as the sub beam is performed in this embodiment. Thus, the irradiation with the main beam L₂ as well as the sub beam as necessary enables a controllability of the melt state of the powder in the predetermined portion to be further improved, compared with a case that the predetermined portion of the powder layer 22 is continuously irradiated with the sub beam and the main beam L₂ for a melt of the powder in the predetermined portion.

According to an embodiment, the main beam and the sub beam may be contacted with each other at the predetermined portion of the powder layer. The phrase “the main beam and the sub beam are contacted with each other” as used herein substantially means that the main beam irradiated region where the irradiation with the main beam is performed and the sub beam-irradiated region where the irradiation with the sub beam is performed are in a point contact or a surface contact.

This embodiment is characterized in a positional relationship between the main beam and the sub beam for the irradiation to the predetermined portion of the powder layer. Specifically, the main beam and the sub beam for the irradiation to the predetermined portion of the powder layer are contacted with each other.

As described above, the sub beam can function as a beam which prevents a movement of the powder to the main beam-irradiated region which is irradiated with the main beam L₂, the sub beam being used for the irradiation to the predetermined portion of the powder layer prior to an use of the main beam. Specifically, the irradiation of the predetermined portion of the powder layer with the sub beam causes only the powder in the sub beam-irradiated region where the irradiation with the sub beam is performed to be in a melt state in advance. Thus, the powder around the sub beam-irradiated region is intentionally moved to the sub beam-irradiated region. As a result, upon an irradiation of the predetermined portion of the powder layer with the main beam, it is possible to prevent a movement of the powder to the main beam-irradiated region where the irradiation with the main beam is performed.

In this embodiment, in addition to the above, the main beam and the sub beam for the irradiation to the predetermined portion of the powder layer are contacted with each other, which causes the main beam-irradiated region and the sub beam-irradiated region to be in a contact with each other. Thus, the irradiation heat energy of the sub beam for a melt of the powder in the sub beam-irradiated region can be transferred to the main beam-irradiated region through a portion where the main beam-irradiated region and the sub beam-irradiated region are in a contact with each other. Thus, it is possible to prevent (or reduce) the irradiation heat energy of the main beam to be provided to the main beam-irradiated region at a later time. The prevention of the irradiation heat energy of the main beam can contribute to a cost reduction, as compared with a state where the main beam-irradiated region and the sub beam-irradiated region are spaced apart from each other.

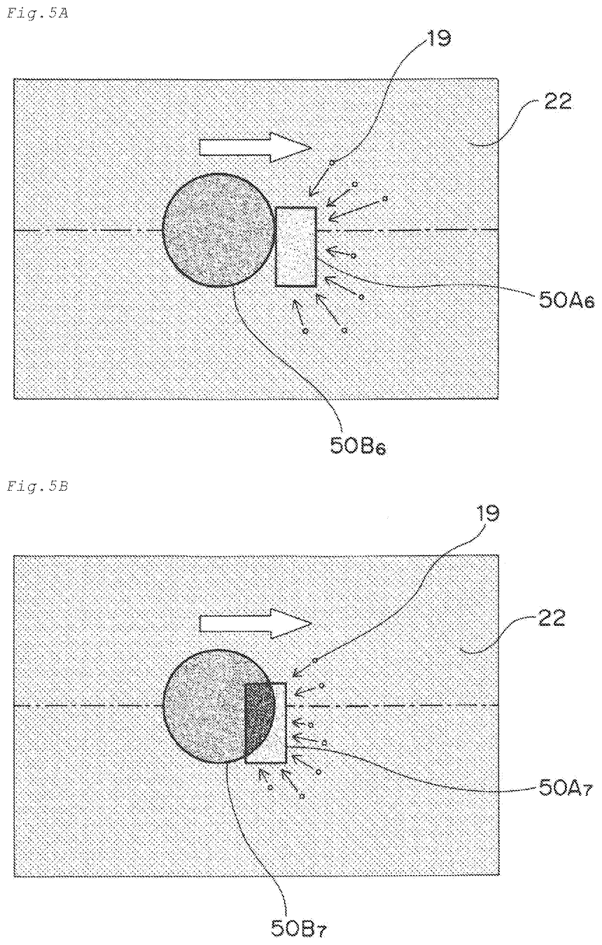

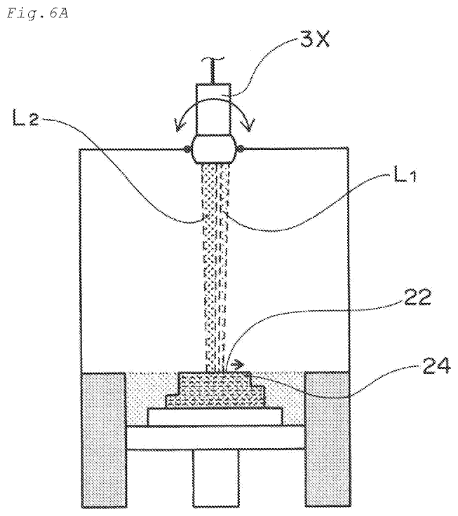

As an example, a main beam-irradiated region 50B₆ and a sub beam-irradiated region 50A₆ may be in a point contact with each other in a top plan view (see FIG. 5A). In this case, an irradiation heat energy of the sub beam for a melt of the powder 19 in the sub beam-irradiated region 50A₆ can be transferred to the main beam-irradiated region 50B₆ through a point contact portion where the main beam-irradiated region 50B₆ and the sub beam-irradiated region 50A₆ are in a point contact with each other.

As another example, it is preferable that a main beam-irradiated region 50B₇ and a sub beam-irradiated region 50A₇ are in a surface contact with each other in a top plan view (see FIG. 5B). In this case, an irradiation heat energy of the sub beam for a melt of the powder 19 in the sub beam-irradiated region 50A₇ can be more suitably transferred to the main beam-irradiated region 50B₇ through a surface contact portion where the main beam-irradiated region 50B₇ and the sub beam-irradiated region 50A₇ are in the surface contact with each other This is due to a fact that a contact area upon the surface contact of the main beam-irradiated region 50B₇ with the sub beam-irradiated region 50A₇ is relatively larger than that upon the point contact of the main beam-irradiated region 50B₆ with the sub beam-irradiated region 50A₆ (see FIG. 5A).

Furthermore, according to an embodiment, an irradiation type of the sub beam for the irradiation to the predetermined portion of the powder layer may be changed.

Generally, A beam for an irradiation to the predetermined portion of the powder layer includes a Gaussian type-beam and a top hat type-beam. The phrase “Gaussian type-beam” as used herein means a beam which has a relatively higher irradiation energy density toward a central region of the beam and which also has a relatively smaller irradiation energy density toward an outer region of the beam in a top plan view, the outer region of the beam corresponding to a region outside the central region of the beam. On the other hand, the phrase “top hat type-beam” as used herein means a beam which has a substantial uniform-relatively medium irradiation energy density over a whole region. The phrase “relatively medium irradiation energy density” as used herein substantially means a substantially intermediate value between the relatively larger irradiation energy density and the relatively smaller irradiation energy density in the Gaussian type-beam.

In this embodiment, it is preferable to use the top hat type-sub beam as the sub-beam for an irradiation to the predetermined portion of the powder layer. In a case of an use of the top hat type-sub beam, the outer region of the top hat type-sub beam has the substantially same predetermined irradiation energy density as that of the central region of the top hat type-sub beam. Thus, in a case when an irradiation with the sub beam is performed before irradiating the predetermined portion of the powder layer with the main beam, not only the powder in the central region of the sub beam-irradiated region where an irradiation with the sub beam is performed but also the powder in the outer region of the sub beam-irradiated region where an irradiation with the sub beam is performed can be in a more suitable melt state in advance. The more suitable melt state makes it possible to more suitably move the powder around the sub beam-irradiated region into the sub beam-irradiated region.

Thus, upon a later irradiation of the predetermined portion of the powder layer with the main beam, it is possible to more suitably prevent a movement of the powder into the main beam-irradiated region where an irradiation with the main beam is performed. The more suitable prevention of the movement of the powder into the main beam-irradiated region enables an increase of the powder at the main beam-irradiated region to be more suitably prevented, which can more suitably provide the base material with the irradiation heat energy of the main beam. Thus, the powder in the main beam-irradiated region and the base material can be more suitably in a melt state, and thus a more suitable new solidified portion (i.e., a composition element of a new solidified layer) can be obtained.

Furthermore, without being limited to the above embodiment, according to an embodiment, an irradiation type of the main beam for the irradiation to the predetermined portion of the powder layer may be also changed.

In this embodiment, it is preferable to use a top hat type-sub beam as the sub beam for an irradiation to the predetermined portion of the powder layer and also to use a top hat type-main beam as the main beam for an irradiation to the predetermined portion of the powder layer.

As described above, in a case of the use of the top hat type-sub beam, the outer region of the top hat type-sub beam has the substantially same predetermined irradiation energy density as that of the central region of the top hat type-sub beam. Thus, not only the powder in the central region of the sub beam-irradiated region but also the powder in the outer region of the sub beam-irradiated region can be in a more suitable melt state in advance. The more suitable melt state makes it possible to more suitably move the powder around the sub beam-irradiated region into the sub beam-irradiated region.

Furthermore, in a case of an use of the top hat type-main beam, an outer region of the top hat type-main beam has the substantially same predetermined irradiation energy density as that of a central region of the top hat type-main beam. Thus, not only the powder in the central region of the main beam-irradiated region hut also the powder in the outer region of the main beam-irradiated region can be in a more suitable melt state in advance. This means that a whole of powders in the main beam-irradiated region can be in a substantial same melt state more suitably. Due to the more suitable substantial same melt state of the whole of the powders in the main beam-irradiated region, a more suitable new solidified portion (i.e., a composition element of a new solidified layer) can be obtained.

According to an embodiment, it is preferable to perform an irradiation with the main beam and the sub beam by using a light beam irradiation means having a DOE (Diffractive Optical Element).

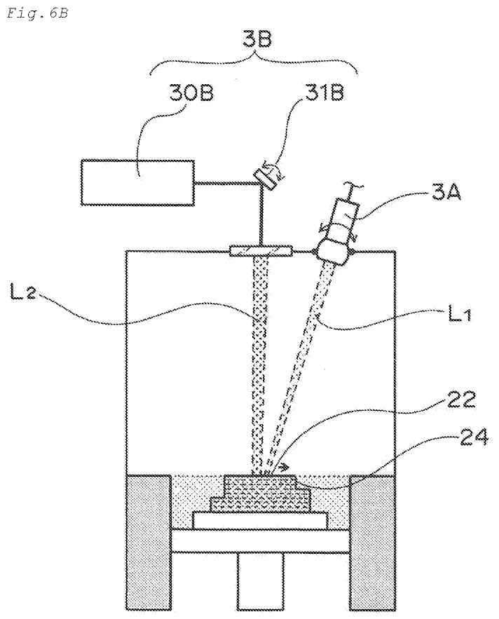

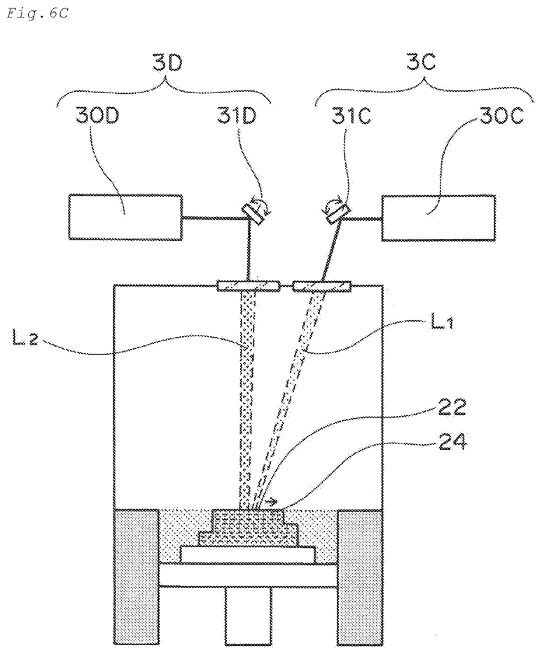

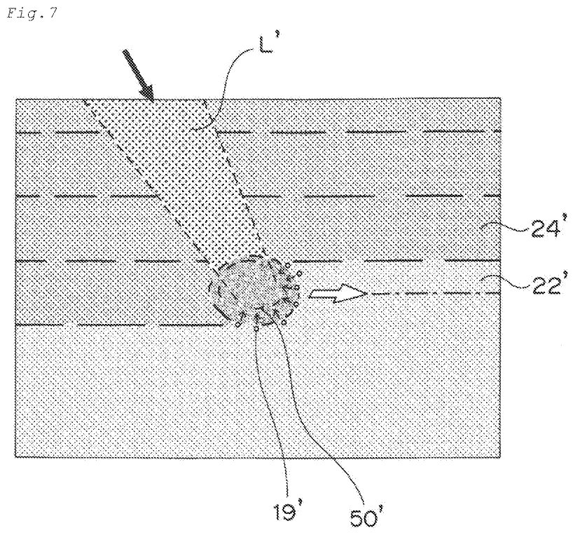

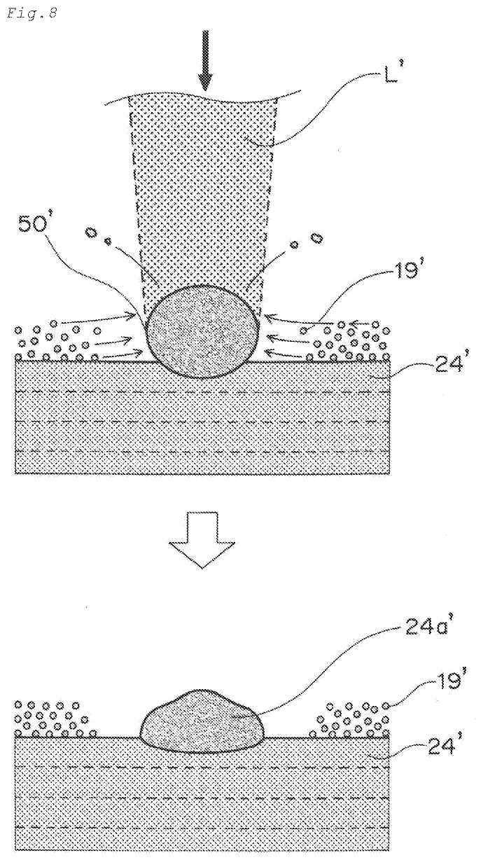

As described above, an embodiment of the present invention has a feature that the predetermined portion of the powder layer 22 (for example, the powder layer 22 on the solidified layer 24) with the main beam L₂ and the sub beam L₁ in view of a prevention of the movement of the powder around the irradiated region into the irradiated region. In an embodiment, as shown in FIG. 6A, it is preferable that an irradiation of the main beam L₂ and the sub beam L₁ is performed by a light beam irradiation means 3X having DOE (Diffractive Optical Element). The DOE is an optical element on which a fine lattice shape is formed on an optical surface by using a diffraction phenomenon. The DOE having any optional groove shape, depth, pitch and the like makes it possible to form a plurality of branched lights each having any optical path and light intensity based on a single laser beam. Namely, upon an use of the DOE, the plurality of the branched lights can be 3X. There is no necessary to use a plurality of laser devices to form the main beam and the sub beam according to an embodiment of the present invention. Accordingly, no necessary to use plurality of laser devices can contribute to a simplification of a device construction for manufacturing a desired three dimensional-shaped object and also a reduction of a device cost.

According to another embodiment, an irradiation with the sub beam may be performed by using a first light beam irradiation means having the DOE, and an irradiation with the main beam may be performed by using a second light beam irradiation means with no DOE.

Specifically, in this embodiment, the irradiation with the sub beam L₁ may be performed by using a first light beam irradiation means 3A having the DOE, whereas the irradiation with the main beam L₂ may be performed by using a second light beam irradiation means 3B having a light beam generator 30B and a galvanometer mirror 31B, as shown in FIG. 6B. In an embodiment of the present invention, there is a case that a plurality of sub beams L₁ may be used in view of a prevention of the movement of the powder around the irradiated region into the irradiated region. In a consideration of such the case, the single first light beam irradiation means 3A having the DOE may be used. Thus, an use of only the single first light beam irradiation means 3A enables at least a plurality of branched lights, i.e., a plurality of sub beams L₁ to be formed.

Without being limited to the above embodiment, in still another embodiment, irradiations with the main beam and the sub beam may be performed by using a third light beam irradiation means with no DOE and a fourth light beam irradiation means with no DOE. Specifically, in this embodiment, an irradiation with the sub beam L₁ may performed by using a third light beam irradiation means 3C having a light beam generator 30C and a galvanometer mirror 31C as shown in FIG. 6C. Similarly, an irradiation with the main beam L₂ may be performed by using a fourth light beam irradiation means 3D having a light beam generator POD and a galvanometer mirror 31D as shown in FIG. 6C.

Although some embodiments of the present invention have been hereinbefore described, these are merely typical examples in the scope of the present invention. Accordingly, the present invention is not limited to the above embodiments. The skilled person will readily appreciate that various modifications are possible. For example, the main beam and the sub beam described above may be used simultaneously. That is, upon the use of the main beam, the sub beam may be used together. Without being limited to this, the main beam and the sub beam as described above may be used separately, i.e., at different timings.

### INDUSTRIAL APPLICABILITY

The manufacturing method of the three-dimensional shaped object according to an embodiment of the present invention can provide various kinds of articles. For example, in a case where the powder layer is a metal powder layer (i.e., an inorganic powder layer) and thus the solidified layer corresponds to a sintered layer, the three-dimensional shaped object obtained by an embodiment of the present invention can be used as a mold for a plastic injection molding, a press molding, a die casting, a casting or a forging. While on the other hand in a case where the powder layer is a resin powder layer (i.e., an organic powder layer) and thus the solidified layer corresponds to a cured layer, the three-dimensional shaped object obtained by an embodiment of the present invention can be used as a resin molded product.

### CROSS REFERENCE TO RELATED PATENT APPLICATION

The present application claims the right of priority of Japanese Patent Application No. 2016-224257 (filed on Nov. 17, 2016, the title of the invention: “METHOD FOR MANUFACTURING THREE-DIMENSIONAL SHAPED OBJECT”), the disclosure of which is incorporated herein by reference.

### EXPLANATION OF REFERENCE NUMERALS

19 Powder
22 Powder layer
24 Solidified layer
24b Contour of Solidified layer
60 Scanning center line
80 Virtual contour
100 Three-dimensional shaped object
L Light beam
L₂ Main beam
L₁ Sub beam
L₁₁ First sub beam
L₁₂ Second sub beam

1. A method for manufacturing a three-dimensional shaped object by alternate repetition of a powder-layer forming and a solidified-layer forming, the repetition comprising:
(i) forming a solidified layer by irradiating a predetermined portion of a powder layer with a light beam, thereby allowing a sintering of the powder in the predetermined portion or a melting and subsequent solidification of the powder; and
(ii) forming another solidified layer by forming a new powder layer on the formed solidified layer, followed by an irradiation of a predetermined portion of the newly formed powder layer with the light beam,
wherein a main beam and a sub beam are used as the light beam, the main beam having an irradiation energy density which is capable of melting the predetermined portion of the powder layer and the solidified layer located below the predetermined portion, the sub beam having an irradiation energy density which is capable of melting only the predetermined portion, and
wherein the predetermined portion is irradiated with the sub beam prior to an irradiation of the predetermined portion with the main beam.

2. The method according to claim 1, wherein the main beam has an irradiation energy density relatively larger than that of the sub beam, and
wherein the sub beam has an irradiation energy density relatively smaller than that of the main beam.

3. The method according to claim 1, wherein
the irradiation with the sub beam causes only the powder at the predetermined portion to be melted in advance prior to the irradiation with the main beam.

4. The method according to claim 1, wherein a plurality of locations are irradiated with the sub beam, the plurality of the locations being opposed to each other across a scanning center line of the main beam.

5. The method according to claim 1, wherein a location distal to a scanning center line of the main beam is irradiated with the sub beam based on a virtual contour to be a contour of the solidified layer.

6. The method according to claim 1, wherein an intermittent irradiation of the predetermined portion with the sub beam is performed.

7. The method according to claim 1, wherein the main beam and the sub beam are contacted with each other at the predetermined portion.
